(19) United States
(12) Patent Application Publication
(10) Pub. No.: US 2002/0032653 A1
(43) Pub. Date: Mar. 14, 2002

(54) Method and system for payment over the internet

(76) Inventor: Daniel Schutzer, Scarsdale, NY (US)

Correspondence Address: George T. Marcou, KILPATRICK STOCKTON LLP, Suite 900, 607 14th Street, N.W., Washington, DC, 20005, US

(21) Appl. No.: 09/933,837

(22) Filed: Aug. 22, 2001

Related U.S. Application Data
(60) Provisional application No. 60/226,670, filed on Aug. 22, 2000.

(51) Int. Cl. G06F 17/60

(52) U.S. Cl. 705/40

(57) ABSTRACT

A method and system for integrated payment services by a financial institution providing on-line payments, risk management, account information protection, escrow services, and payee holding accounts. The system involves payments via web site, email, Internet phone, and personal appliances, such as personal digital assistants (PDAs). The method and system empowers non-merchants with the capability of receiving integrated payment services over a communications network. Payments may be made directly from a payer's checking or credit card account, and the payer and payee may individually select the preferred manner of payment in terms of timeliness, guarantees, and fees.

### CROSS-REFERENCE TO RELATED APPLICATIONS

This application claims priority to, and herein incorporates by reference, applicant's copending U.S. Provisional Application No. 60/226,670 filed Aug. 22, 2000.

### FIELD OF THE INVENTION

The present invention relates generally to payment via a communications network, and more particularly, but not by way of limitation, to a method and system for enabling on-line payments between individuals.

### BACKGROUND

With the emergence of the Internet, tools are being developed to facilitate electronic payments. However, these tools are one dimensional solutions in addressing the transaction between the payer and payee. There is a need for a method and system for integrated payment capabilities between two individuals by a financial institution providing completely on-line payments, risk management, account information protection, escrow services, and payee holding accounts.

In the physical world, payment between individuals is traditionally accomplished via cash and check transactions. Card-based payment systems are generally reserved for transactions involving payment to a merchant.

Cash payments are the simplest of the physical payment systems. The check payment system requires the payer to have a demand deposit account (DDA). The check is an order to the payer's financial institution to pay a specified amount to the named payee. The payee can take the check to the payer's institution and cash the check. Where the payer and payee do not hold accounts in the same financial institution, the payee lodges the check with its financial institution, known as the collecting bank. The collecting bank will collect for the payee. Usually, credit is immediately made to the payee's account when the check is lodged. However, funds are usually not immediately available.

There are several card-based systems that enable payment. One card-based system is the credit card system, where payments are set against a special purpose account associated with some form of installment-based repayment or a revolving line of credit. Credit cards usually have a maximum charge limit set by the card issuer and the interest rate on the unpaid balance is usually several times the base lending rate.

Debit cards represent another card-based system. Debit cards are linked to a checking or savings account. Usually, a payment cannot be made unless there are funds available to support it. This system is often referred to as a paperless check. Credit and debit cards enable the payer to pay the payee, if the payee has a merchant (acquiring) bank relationship. Currently, over the Internet, only credit and debit cards are generally accepted.

Charge cards are part of another card-based system. Charge cards work similarly to credit cards in that payments are set against a special purpose account. The main difference is that the entire bill for the charge must be paid at the end of the billing period.

Other payment systems involve bank wire and Automated Clearing House (ACH) credit. The Federal Reserve operates the Fedwire payment system and the Clearing House Interbank Payment System (CHIPS), a private sector organization, also operates a system. Usually, these systems involve payments between corporations and to and from government. ACH payment is similar to paper clearing with the exception of having payment instructions in electronic form. This system is extensively used by employers to pay wages directly into an employee's bank account.

Both bank wire and ACH credit requires that the payer know the payee's account information, and the payee's financial institution must be able to accept an electronic transfer of funds from the payer's institution. This is not always universally the case, which is why with many electronic bill payments systems a check is often printed and mailed to the payee even though the payment instructions originated electronically.

Another payment system is on-line bill payment. In this case, the payment is made electronically if the payment has the appropriate account information for electronic transfer, and arrangements have been made between the respective financial institutions. Otherwise, a check is printed and mailed to the payee's address. Naturally, printing and mailing a check moves the transaction off-line, thereby adding time and cost. Furthermore, the on-line bill payment solution is only good if the payer has an account with a bill payment processor or has provided the bill payment processor with his/her banking information and has provided written permission that gives the bill payment processor the authority to debit the payer's account.

Accordingly, there is a need for a method and system for integrated payment services by a financial institution providing completely on-line payments, risk management, account information protection, escrow services, and payee holding accounts.

### SUMMARY OF THE INVENTION

The present invention overcomes the above-noted and other shortcomings by providing a novel and improved method and system that meet the aforementioned needs.

These needs are met through a method and system for integrated payment services by a financial institution providing completely on-line payments, risk management, account information protection, escrow services, and payee holding accounts. The present invention involves, for example, the following Internet payment applications: Payments made via web site, email, Internet phone, and personal appliances, such as personal digital assistants (PDAs).

In accordance with the present invention, in receiving payment, if the payer is paying out of payer's direct deposit account (DDA) at a financial institution, then the institution can debit funds from the payer's account. The payer may therefore preauthorize payments to be made from payer's accounts. If the only account the payer has with the institution is a credit card account, the institution can add the expense to the payer's credit card bill, even though the institution is not processing the transaction as a credit card transaction because the payee is not an authorized merchant.

If the payer does not have an account with the institution, the institution can receive payment in one of two ways: 1) If the payer registers with the transacting institution by giving the payee's account information (from the payer's preexisting institution), and if his/her preexisting institution accepts an electronic debit, the account is debited, for example, via ACH; and 2) If the payer wishes to pay using a credit card, the transacting institution acts as a merchant (the institution is also the merchant acquiring bank). The institution would pass on the association fees to be paid to the payee unless the transaction is an “on-us” transaction whereby the institution can bypass the association fees.

If the payee does not have a preexisting account with the transacting institution, the institution can accept funds from the payer, which it uses to open an account for the payee. The payee can, in turn, pay from this account in future payments to another payee. Depending upon the payee's credit, the institution can also provide this account with a line of credit. The line of credit may be allowed to grow with the institution's growing knowledgebase on the payee, for example, through behavioral scoring.

Additionally, if the payee does not have an account with the transacting institution and does not desire an account to be established, the present invention provides for an ACH credit to the payee's preexisting account at another institution. Further, if the payee does not have an account with any institution, the present invention provides for the placement of funds in a holding account at the transacting institution for the payee. The institution may email the payee an access code which the payee can use to withdraw cash from an automated teller machine (ATM); or use the funds to, in turn, make payments to another person, for example, over the Internet.

If both payer and payee have an account with the transacting institution, the present invention enables payment through internal transfer from the payer's account to the payee's account, either as available funds in a DDA or as a credit in a credit card account.

Risk management is implemented as part of the present invention. Because the ACH debit involves the risk of insufficient funds, the institution generally will not release the funds to the payee until it is sure the funds are available. The risk of charge-back would require the institution to wait until the 90 day dispute period before releasing the funds to the payee, unless the payee establishes a line of credit with the institution or the institution has enough previous experience with the payer and is willing to take the risk. The institution can offer the payer and payee multiple options regarding terms, including, for example, whether risk is to be transferred to the payee or payer, and whether the fees are to be paid by payer or payee.

As part of the present invention, other services are easily integrated/added to the payment process. For example, the institution may hold the transferring of funds to the payee until delivery conditions are met (e.g. were goods received, were goods received and in the condition promised)—in other words, an escrow service. Other services incorporated into the present invention include the issuance of a line of credit, insurance coverage (notably, insurance on purchased items), overdraft protection, etc.

The present invention also incorporates personal account protection. If both parties are registered with the institution, the institution would not need to send sensitive data to get payment instructions. The institution would 1) receive the payment request from payer, 2) acknowledge the request, 3) ask for confirmation by payer, and 4) notify the payee of the availability of funds which the payee may keep on deposit, withdraw, transfer, or, in turn, make payment to another payee.

Further, the invention enables the payers and payees to individually select their preferred means of payment in terms of parameters such as timeliness of payment, guarantees, and fees. That is, the payer may choose to pay out of their credit account, be billed, and actually debited later. Whereas the payee may choose to receive the funds immediately in real-time, with no risk of payment being charged-back or insufficient funds, as if it were an ATM debit card POS transaction. If the payer agrees to be debited in real-time, the fees to the payer would be less, and if the payee were to agree to an overnight ACH, and take the chance of insufficient funds, the fee to the payee would be less. In this case, the payer might be willing to accept real-time debit if the fees were less or zero, and the payee might be willing to take the risk of insufficient funds if the merchant knew and trusted the payer and the fees were substantially less.

To achieve the stated and other objects of the present invention, as embodied and described below, the invention includes a method for conducting an electronic transaction between a first party and a second party, comprising: receiving payment instructions electronically from the first party by a third party; determining whether the first party has an existing checking account and credit card account with the third party; carrying out the instructions, the instructions directed at satisfying an obligation to the second party by the first party by debiting directly from the first party's existing checking account or credit card account, or a newly established account; integrating financial services in satisfying the obligation of the first party to the second party; and wherein the second party is provided an access code to retrieve funds from an automated teller machine (ATM).

A further embodiment of the present invention includes a system for conducting an electronic transaction between a first party and a second party, comprising: a communications server configured to receive instructions electronically from the first party to a third party; a database configured to store information regarding whether the first party has an existing checking account and credit card account with the third party, wherein the instructions are directed at satisfying an obligation to the second party by the first party by debiting directly from the first party's existing checking account or credit card account, or a newly established account; a database configured to store information integrating financial services in satisfying the obligation of the first party to the second party; and an automated teller machine (ATM) for the second party to retrieve the payment from the first party.

Additional objects, advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 depicts a physical payment transaction;

FIG. 2 depicts a credit card transaction;

FIG. 3 represents an electronic transaction over a communications network;

FIG. 4 represents an embodiment of the present invention;

FIG. 5 represents another embodiment of the present invention;

FIG. 6 represents an embodiment of the present invention whereby the payer and payee both maintain accounts at the transacting institution;

FIG. 7 represents an embodiment of the present invention whereby only the payer maintains an account at the transacting institution;

FIG. 8 represents an embodiment of the present invention whereby only the payee maintains an account at the transacting institution;

FIGS. 9-13 are flow diagrams representing an embodiment of the present invention; and

FIG. 14 represents a further embodiment of the present invention relating to integrated services and account information protection.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents.

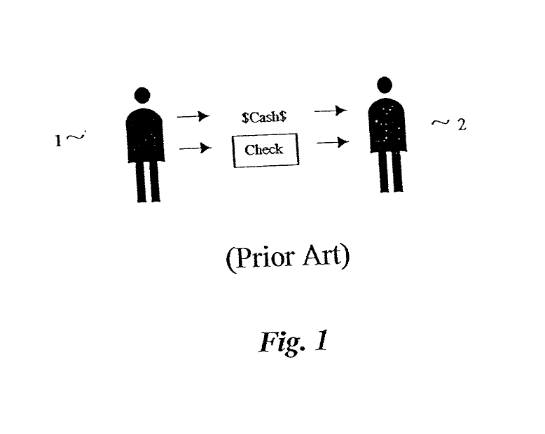

In FIG. 1, the most fundamental payment systems between individuals is shown. The payer 1 pays the payee 2 with cash or a payment instrument, for example, a check. The check payment system requires the payer to have a demand deposit account (DDA).

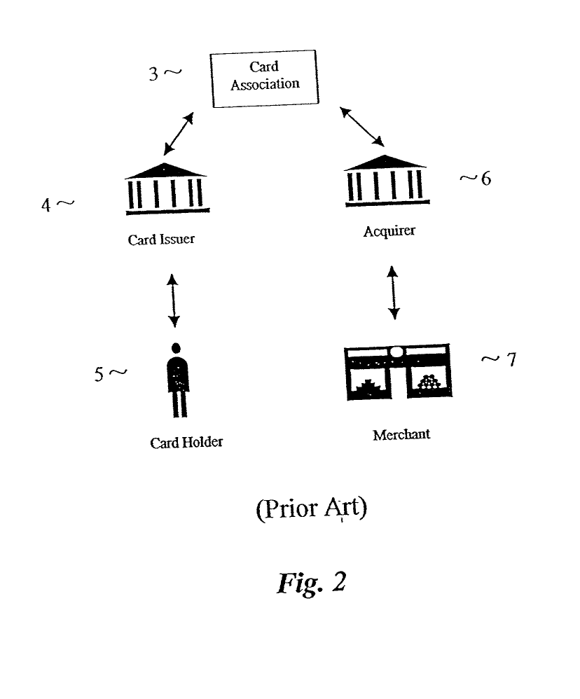

In FIG. 2, a credit card transaction is shown. The credit card transaction being the most widely used payment system over the Internet. In a credit card transaction, financial institutions belong to a card association 3. These institutions may act as a card issuer 4 by issuing cards to a customer, who becomes a card holder 5. These institutions will issue a card and maintain a credit card account for that customer. When the card is used in a transaction, the transaction will be posted on the credit card account.

The same institution or another institution acts as an acquirer 6 for customers, for example merchants 7, who desire to accept credit card payments. The institution will typically provide equipment and software to process the payments at the merchant's site. The acquirer will usually establish the procedures for on-line verification of any transaction. The merchant will get the cardholder's information at the point of sale. Depending on the on-line verification procedures, the transaction may be completed without a verification, for example, if the transaction does not exceed a certain limit, or an on-line verification may be made. Batch transactions are then sent to the acquirer for processing.

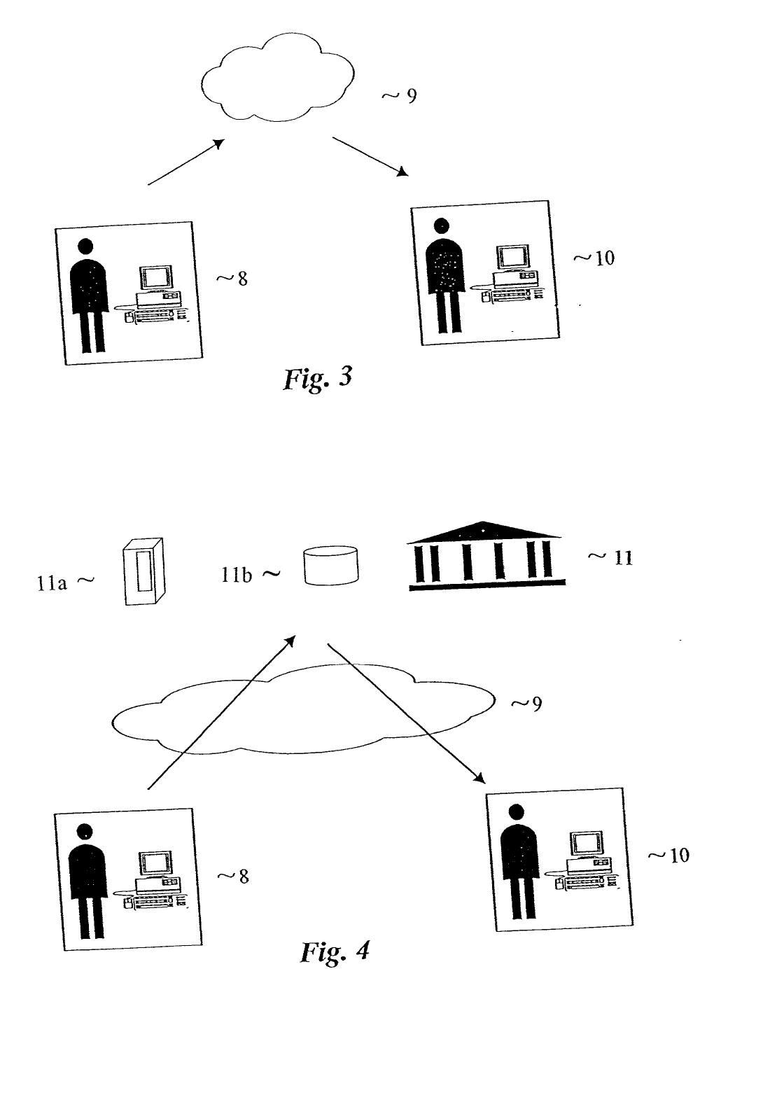

FIG. 3 shows a transaction being conducted over a communications network. In FIG. 3, a payer at a personal computer 8 communicates with a payee at a personal computer 10 over the Internet 9. If the payee 10 is a merchant selling goods or services over the Internet 9, payment for those goods and services is generally made with credit cards. However, as noted above, a credit card infrastructure must be established between the payer and payee to enable the transaction. The present invention provides for a method and system for integrated payment services by a financial institution which provides completely on-line payment capabilities between a payer and payee without requiring the payee to accept credit, debit, or charge card payments.

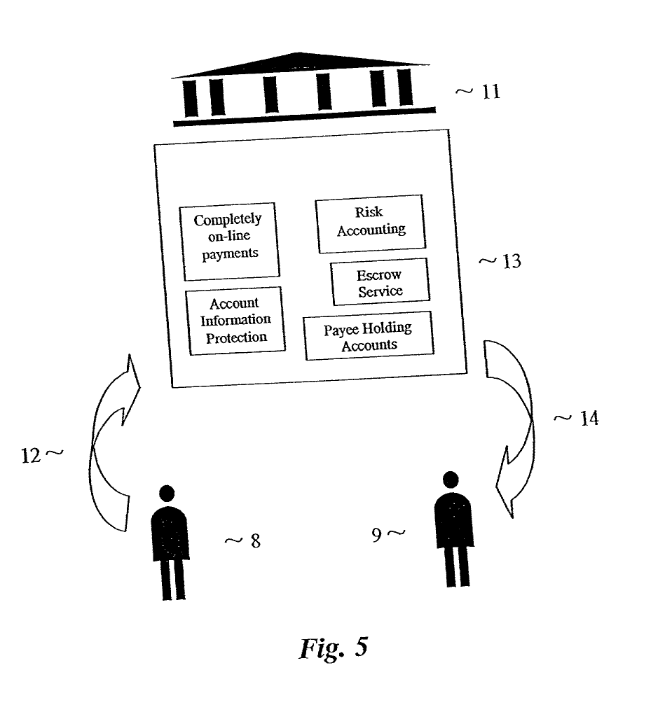

FIG. 4 shows an embodiment of the present invention. A payee 10 who is not equipped to directly accept credit, debit, or charge card payments is empowered to receive payment from the payer 8 over the Internet via a financial institution 11. The servers 11a and databases 11b being configured for conducting the electronic transaction. In FIG. 5, the financial institution 11 receives payment instructions via data communication 12 from the payer 8. The institution 11 then sends the payment via data communication 14 for access by the payee 9. The financial institution provides integrated payment services 13 including, but not limited to, completely on-line payments, account information protection, risk management, escrow services, and the establishment of payee holding accounts.

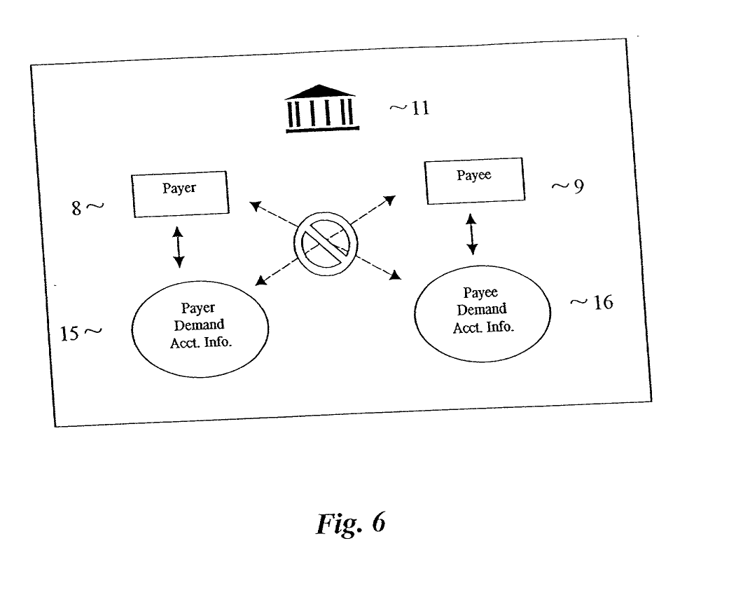

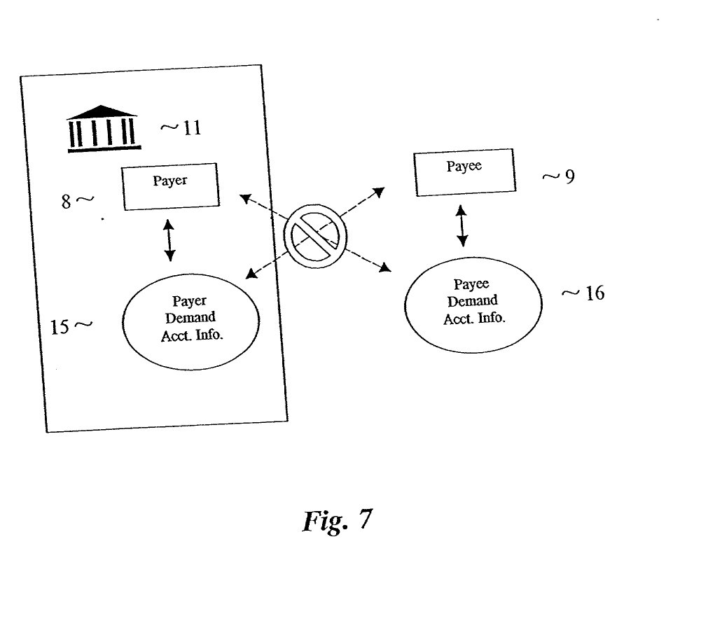

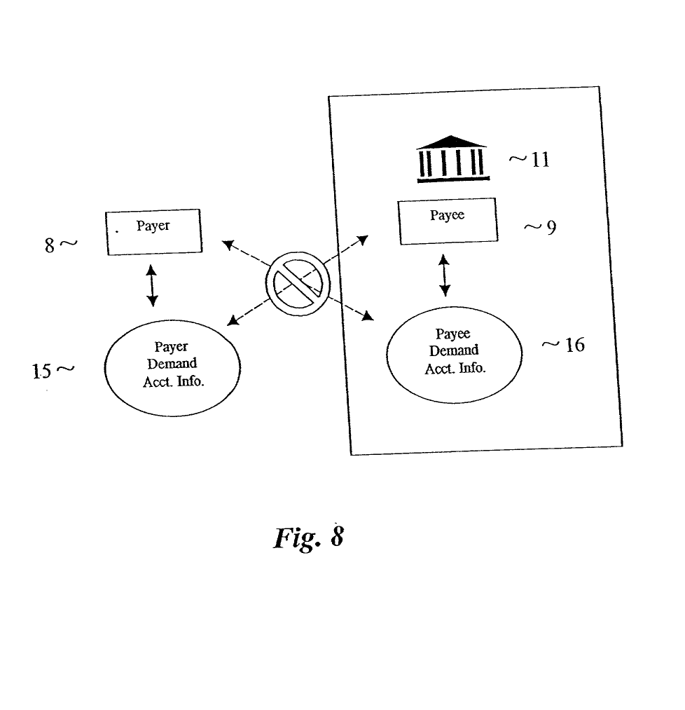

Embodiments of the present invention permit electronic payment from the payer to payee while at the same time preventing the disclosure of account information between the two parties. In FIG. 6, the payer 8 and payee 9, maintain accounts from which payment is to be made 15 and payment is to be received 16, respectively, both at the same financial institution 11. In FIG. 7, only the payer 8 maintains an account with the transacting institution 11 from which payment is to be made. In FIG. 8, only the payee 9 maintains an account with the transacting institution 11 from which payment is to be received.

The present invention is perhaps best further described by way of an example (In the example, the payee does not accept credit, debit, or charge card payments):

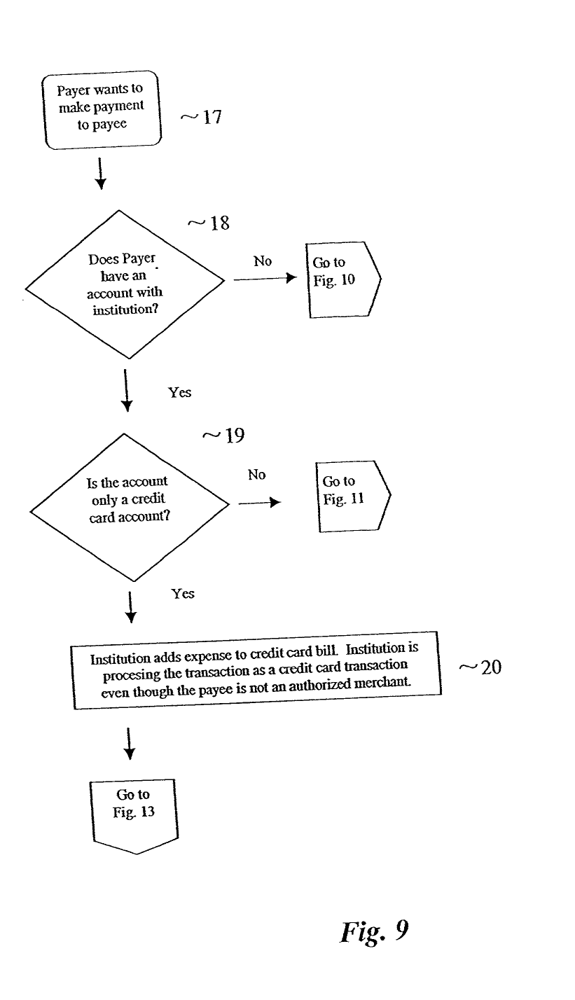

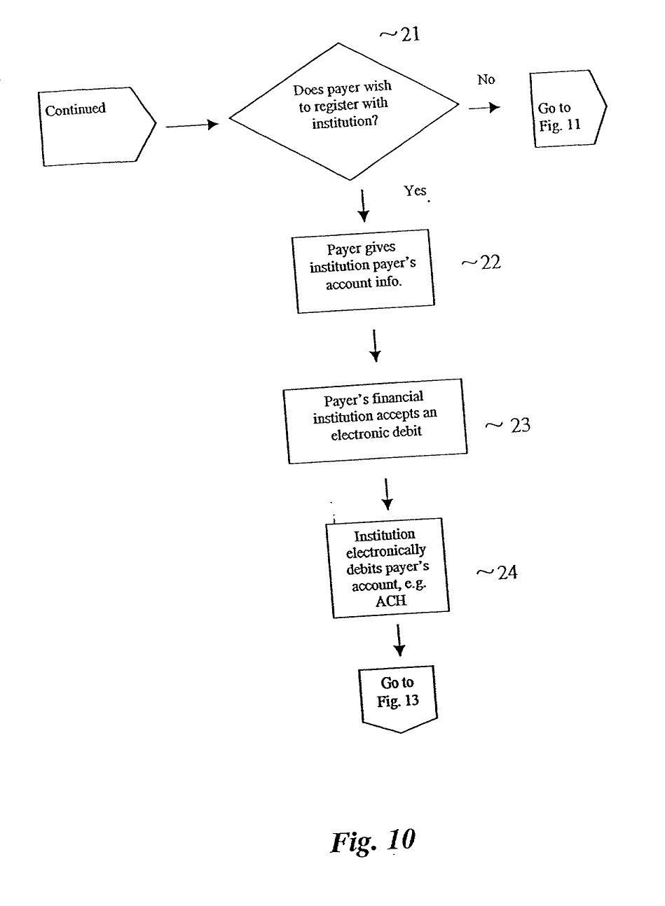

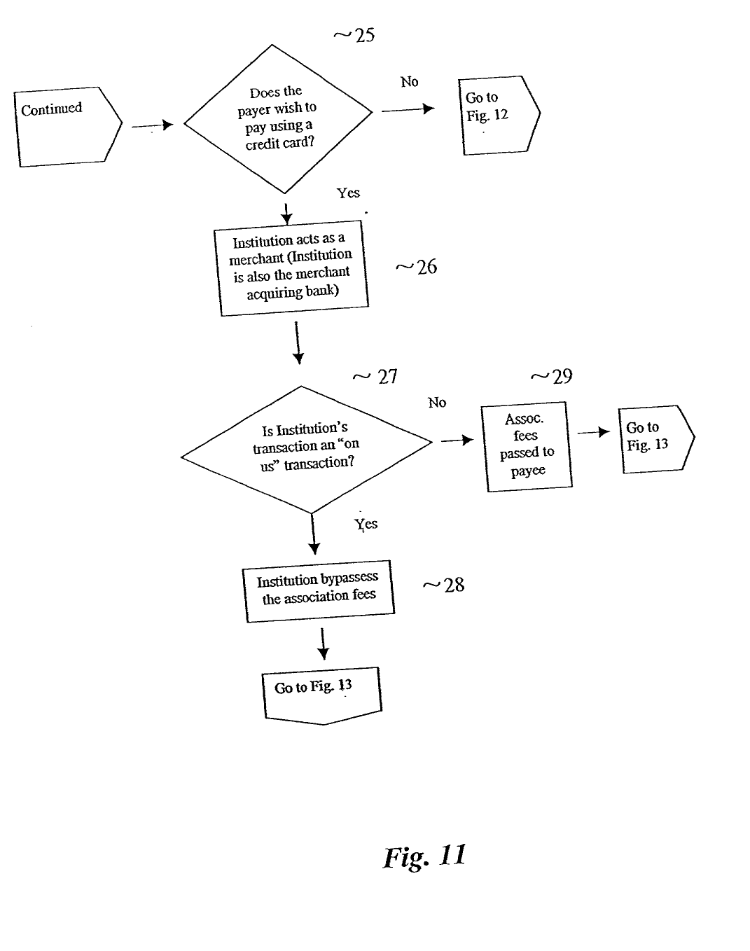

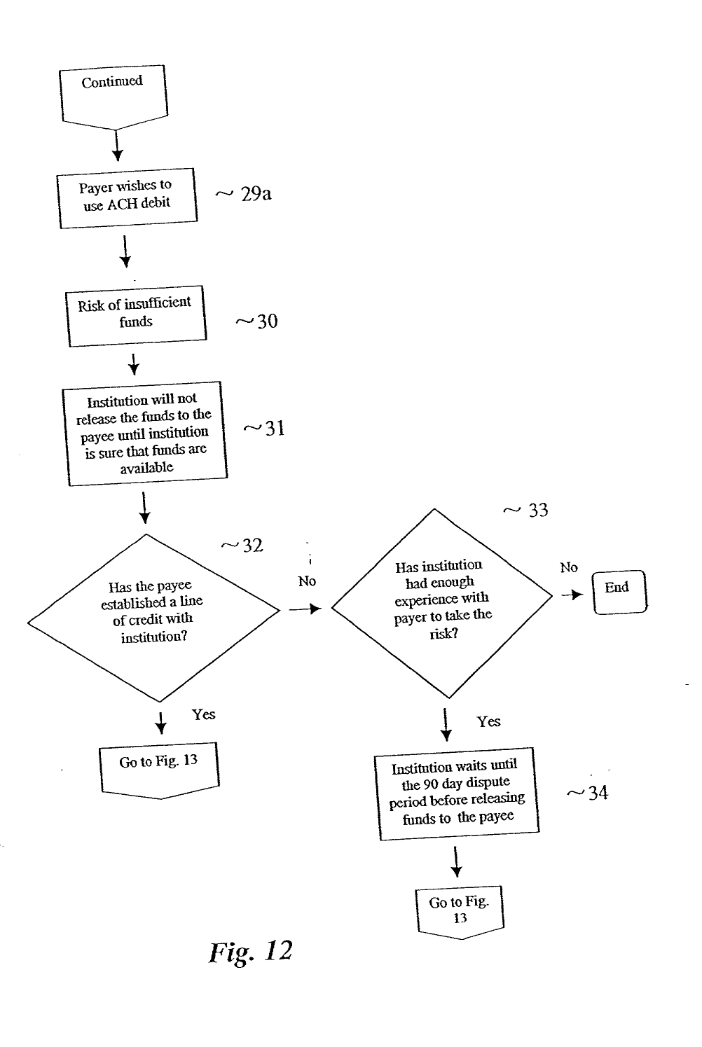

FIGS. 9 through 14 show the method of an embodiment of the present invention. The method begins with the payer wanting to make a payment to a payee 17. The first issue is whether the payer desires to pay from an account maintained at the transacting institution 18. In permitting the payment, the institution debits the funds from the payee's account, whether it be a demand deposit account (DDA) or credit card account. If the only account the payee has with the institution is a credit card account 19, the institution may add the expense to the payee's credit card bill 20, even though the institution is not processing the transaction as a credit card transaction, because the payee is not an authorized merchant.

If the payee does not have an account with the institution, then the institution can receive payment in one of the following ways: a) The payer registers with the institution 21 by giving the institution his/her account information 22. If the payer has an existing account with another institution, and that institution accepts an electronic debit 23, the transacting institution can debit the payer's account; e.g. via the Automated Clearing House (ACH) system 24; and b) If the payer wishes to pay using a credit card 25, the transacting institution acts as a merchant 26 (the institution is also the merchant acquiring bank). If the transaction is “on us” 27, the association fees are bypassed 28. Otherwise the transaction fees are passed to the payee 29.

If an ACH debit is utilized by the transacting institution 29a, there is a risk of insufficient funds 30. The present invention incorporates risk management whereby the transacting institution will not release the funds to the payee until it is ascertained that the funds are available 31. The risk of charge-back would require the institution to wait until the 90 day dispute period before releasing the funds to the payee 34, unless the payee establishes a line of credit 32 or the transacting institution has enough previous experience with the payer to minimize the risk 33. The transacting institution further addresses the risks by offering the payer and payee various choices regarding the terms, for example, whether the risk is transferred to payee or payer, the amount of fees assessed, etc.

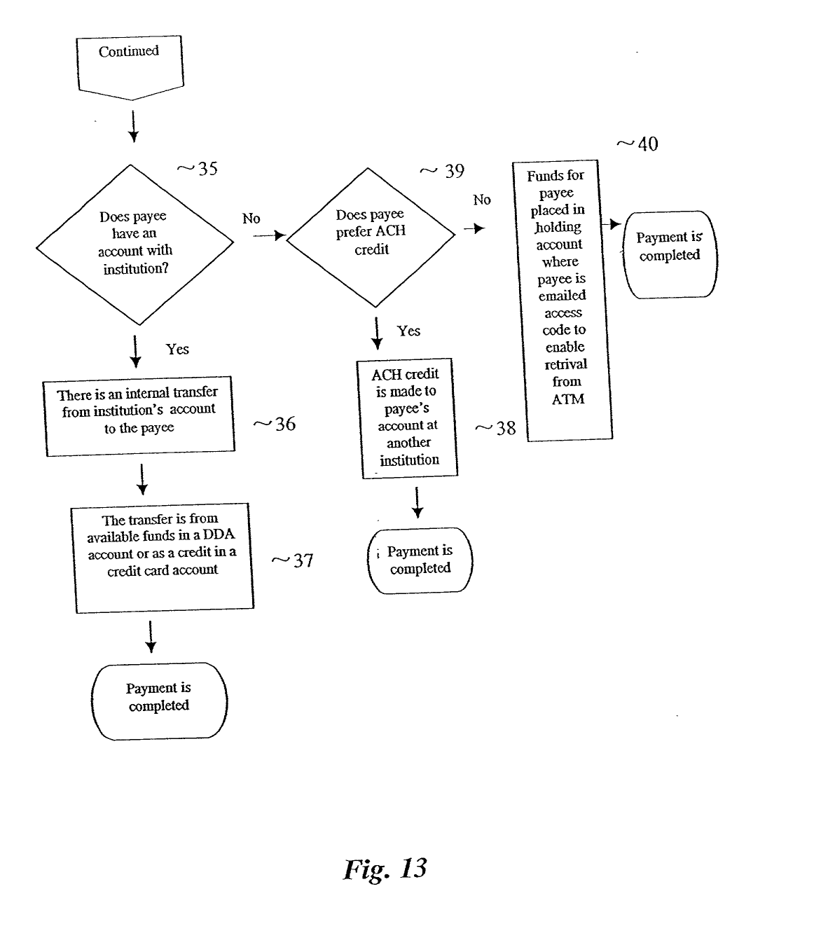

FIG. 13 shows the final phase of the transaction—making funds available to the payee. The transacting institution pays the payee in a number of ways; namely: a) Internal transfer to the payee 36 if the payee has an account with the transacting institution 35; either as available funds in a DDA account or as a credit in a credit card account 37; and b) ACH credit to the payee's account if the payee prefers 39. The payee needs to have an account with another institution that accepts electronic transfers from the transacting institution 38; alternatively, the transacting institution can place the funds in a holding account 40 for the payee and email the payee an access code which he/she can use to withdraw cash from an ATM. The payee is also able to use funds in this account to pay someone else over the Internet.

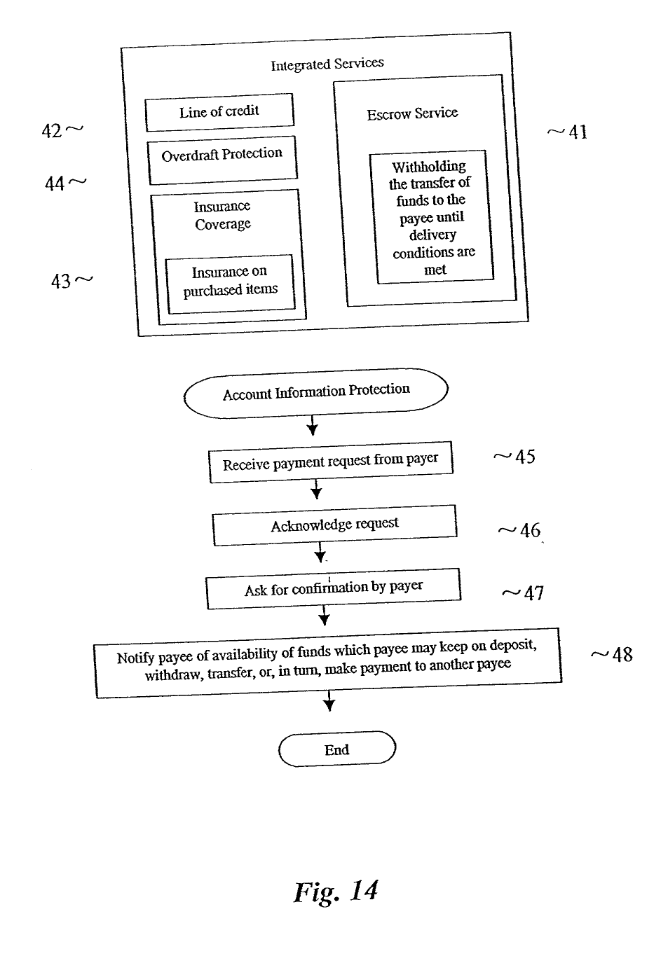

FIG. 14 shows services, in accordance with one embodiment of the present invention, which are integrated into the on-line payment system. For example, withholding the transfer of funds to the payee until delivery conditions are met (e.g. were goods received, were goods received and in the condition promised)—in other words, an escrow service 41. Other services incorporated into the present invention include the issuance of a line of credit 42, insurance coverage 43 (notably, insurance on purchased items), overdraft protection 44, etc.

The present invention, shown in FIG. 14, incorporates personal account protection. If both parties are registered with the institution, the institution would not need to send sensitive data to get payment instructions. The institution would a) receive the payment request from payer 45, b) acknowledge the request 46, c) ask for confirmation by payer 47, and d) notify the payee of the availability of funds which the payee may keep on deposit, withdraw, transfer, or, in turn, make payment to another payee 48.

Although only a few exemplary embodiments of this invention have been described in detail above, those skilled in the art will readily appreciate that many modifications and variations are possible in the exemplary embodiments without materially departing from the novel teachings and advantages of the invention. Accordingly, all such modifications and variations are intended to be included within the scope of this invention.

I claim:

1. A method for conducting an electronic transaction between a first party and a second party, comprising:
receiving payment instructions electronically from the first party by a third party;
determining whether the first party has an existing checking account and credit card account with the third party;
carrying out the instructions, the instructions directed at satisfying an obligation to the second party by the first party by debiting directly from the first party's existing checking account or credit card account, or a newly established account; and
integrating financial services in satisfying the obligation of the first party to the second party.

2. The method for conducting the electronic transaction of claim 1, wherein the second party receives payment via an automated teller machine (ATM).

3. The method for conducting the electronic transaction of claim 1, wherein the first party and second party individually select their preferred method of payment in terms of timeliness of payment, guarantees, or fees.

4. The method for conducting the electronic transaction of claim 1, wherein the electronic transaction occurs via the Internet.

5. The method for conducting the electronic transaction of claim 1, wherein the third party is a bank.

6. The method for conducting the electronic transaction of claim 1, wherein the first party establishes a relationship with the third party, by providing the third party information regarding a preexisting account with a separate institution used by the first party.

7. The method for conducting the electronic transaction of claim 6, wherein the separate institution accepts an electronic debit.

8. The method for conducting the electronic transaction of claim 7, wherein the third party debits the preexisting account via Automated Clearing House (ACH) debit.

9. The method for conducting the electronic transaction of claim 1, wherein the first party makes payment into an account by using a credit card and the third party acts as a merchant.

10. The method for conducting the electronic transaction of claim 9, wherein the transaction is “on-us”.

11. The method for conducting the electronic transaction of claim 10, wherein the credit card association fees are passed on to the second party.

12. The method for conducting the electronic transaction of claim 11, further comprising:
waiting to ensure funds are available to the third party prior to releasing any funds to the second party.

13. The method for conducting the electronic transaction of claim 1, wherein the first party establishes a line of credit with the third party.

14. The method for conducting the electronic transaction of claim 13, wherein the third party has experience with the first party and is willing to assume a risk.

15. The method for conducting the electronic transaction of claim 1, wherein the first party and the second party have accounts with the third party, further comprising:
transferring funds internally from the account of the first party to the account of the second party.

16. The method for conducting the electronic transaction of claim 15 wherein one of the accounts of the second party is a direct deposit account.

17. The method for conducting the electronic transaction of claim 15, wherein one of the accounts of the second party is a credit card account.

18. The method for conducting the electronic transaction of claim 1, wherein the financial services includes an overdraft protection.

19. The method for conducting the electronic transaction of claim 1, wherein the financial services includes insurance coverage.

20. The method for conducting the electronic transaction of claim 19, wherein the insurance coverage is insurance on purchased items.

21. The method for conducting the electronic transaction of claim 1, wherein the financial services includes an escrow service.

22. The method for conducting the electronic transaction of claim 21, wherein the escrow service includes withholding a transfer of funds to the second party until delivery conditions are met.

23. The method for conducting the electronic transaction of claim 1, wherein the financial services includes account information protection.

24. The method for conducting the electronic transaction of claim 23, wherein the first and second party do not have access to the other party's account information.

25. The method for conducting the electronic transaction of claim 1, further comprising:
placing a payment to the second party into a holding account.

26. The method for conducting the electronic transaction of claim 25, wherein the second party is notified of the payment via email.

27. The method for conducting the electronic transaction of claim 26, wherein the second party is provided an access code to retrieve funds from the holding account from an automated teller machine (ATM).

28. A system for conducting an electronic transaction between a first party and a second party, comprising:
a server configured to receive instructions electronically from the first party to a third party;
a database configured to store information regarding whether the first party has an existing checking account and credit card account with the third party;
wherein the instructions are directed at satisfying an obligation to the second party by the first party by debiting directly from the first party's existing checking account or credit card account, or a newly established account; and
a database configured to store information integrating financial services in satisfying the obligation of the first party to the second party.

29. The system for conducting the electronic transaction of claim 28, further comprising:
an automated teller machine for the second party to retrieve a payment from the first party.

30. The system for conducting the electronic transaction of claim 28 wherein the electronic transaction occurs via the Internet.

31. The system for conducting the electronic transaction of claim 28 wherein the first party and second party individually select their preferred method of payment in terms of timeliness of payment, guarantees, or fees.

32. The system for conducting the electronic transaction of claim 28, wherein the second party is notified of a payment via email.

33. The system for conducting the electronic transaction of claim 28, wherein the first party makes payment into an account by using a credit card and the third party acts as a merchant.
